(19) United States
(12) Patent Application Publication
(10) Pub. No.: US 2002/0162904 A1
(43) Pub. Date: Nov. 7, 2002

(54) Washing gun

(76) Inventor: Erik Kristensen Worm, Nibe (DK)

Correspondence Address: LARSON & TAYLOR, PLC, 1199 NORTH FAIRFAX STREET, SUITE 900, ALEXANDRIA, VA, 22314, US

(21) Appl. No.: 10/134,460

(22) Filed: Apr. 30, 2002

(30) Foreign Application Priority Data
May 4, 2001 (EP) 01110811.5

(51) Int. Cl. B05B 7/02

(52) U.S. Cl. 239/525; 239/587.1

(57) ABSTRACT

According to the invention, there is provided a washing gun for instance for use with a high-pressure washer, where the washing gun essentially comprises a handgrip section (1) comprising a suitable trigger mechanism (12, 13) and furthermore comprising an inlet portion (3) for the washing fluid and a nozzle section (4) between which inlet portion (3) and nozzle section (4) there is provided a suitable valve contained in a valve house (2). The inlet portion (3) is coupled to the valve house (2) and the handgrip section (1) in such a manner that it can rotate 360 degrees about the longitudinal axis (X) through the valve house (2) and nozzle section (4). By these means it is thus possible during use of the washing gun to position the hose providing washing fluid to the fluid inlet (5) in the inlet portion (3) in an optimal manner relative to the user of the washing gun and to the object being treated. According to the invention there is furthermore as an option provided retainment means for locking the inlet (5) at certain predetermined angular orientations about the longitudinal axis (X) or for providing a break function impeding the rotation of the inlet (5) about the longitudinal axis (X).

### TECHNICAL FIELD

The present invention relates to washing guns and more particularly to means for providing such guns with washing fluid.

### BACKGROUND ART

Washing guns, for instance for high pressure washing, generally comprise a gun house provided with a handgrip section, said gun house containing a valve for providing a controllable amount of the washing fluid from a fluid inlet to a nozzle of the washing gun. The valve is activated by a suitable trigger mechanism provided somewhere on or adjacent to the handgrip section. The washing gun is furthermore provided with an inlet for the washing fluid, which inlet during operation is coupled to a hose connecting the washing gun with a suitable fluid source, said inlet being often located either at the bottom part of the handgrip section or elsewhere at a suitable location on the gun house.

Washing guns of the above kind are for instance described in U.S. Pat. No. 6,000,637 (High-pressure washing gun) or DE 38 31 011 (Kombinierte Wachsvorrichtung und Wasserstrahlpistole), but many other washing guns of the above kind are known within the art.

It is a characteristic feature of most prior art washing guns that the fluid inlet is attached to the main body of the washing gun in a fixed manner. During use of the washing gun, the orientation of the inlet, and hence the orientation of a hose providing fluid to the washing gun, cannot always be optimal due to the fixed connection between washing gun and inlet/hose, a disadvantage which may be very serious for instance during use in restricted spaces. In order to compensate for this non-optimal orientation of inlet and/or hose, the user may have to handle the washing gun in a manner which is not optimal from an ergonomic point of view, leading for instance to stress and fatigue of the muscles in the hand and arm of the user.

FR 2.357.310 describes a spray gun for paint comprising a rotatably mounted valve house provided with a transversally extending inlet for paint. The valve house can rotate about its longitudinal axis relative to the handgrip section of the gun between two 180 degrees angularly displaced orientations and the valve house is during operation locked in either of these positions. The valve house is furthermore provided with passageways for the provision of pressurized air to the nozzle part of the gun for producing the spray of paint from the nozzle outlet. The passageways for pressurized air extends through the handgrip section and via suitably sealed interfaces to corresponding passageways for pressurized air through the valve house to the nozzle section. Due to the need for thourouhly sealed interfaces in the passageways for pressurized air the valve house must during operation be firmly locked to the handgrip section with either of the above mentioned orientations of the valve house, and hence for the inlet for paint, about the longitudinal axis through the valve house. In order to shift from one angular orientation of the inlet to the other it is necessary to loosen a nut located at one longitudinal end of the valve house, displace the valve house longitudinally, rotate the valve house to the other angular orientation and fasten the nut again. Apart from the fact that the angular orientation of the inlet for paint is constrained to said two orientations it is not possible during operation continuously to change the angular orientation of the inlet, which would often be desirable, if the paint is provided to the gun from a remote container via a hose.

### SUMMARY OF THE INVENTION

According to the preceding description, it is an object of the present invention to provide a washing gun, for instance for high pressure washing, which solves, or at least reduces, the above problems caused by non-optimal orientation of the fluid inlet of the washing gun.

This object is attained with a washing gun according to the characterising clause of claim 1. Details of a specific embodiment of the invention are defined in the dependent claims.

According to the invention, the washing gun comprises a handgrip section, a valve house provided with an inlet portion and a nozzle section, where said valve house is designed in such a manner that it can be rotatably connected to said handgrip section for rotation about the longitudinal axis through the valve house.

The inlet portion is provided with an inlet for washing fluid, to which inlet for instance a hose connecting the washing gun with a suitable fluid source can be coupled, the inlet being furthermore provided at an angle a relative to said longitudinal axis through the valve house.

According to one specific embodiment of the invention, said angle α is substantially equal to 90 degrees, but other values of a may also be used, depending on the overall layout of the washing gun.

According to the invention the valve house can be rotated non-limited and continuously about said longitudinal axis, thus making it possible to position the inlet on the inlet portion relative to the handgrip section in an optimal manner according to the specific use. According to one embodiment of the invention the inlet can be oriented at any angle of rotation about the longitudinal axis, but it is also possible to provide the inlet portion and corresponding parts of the handgrip section with suitable retention mechanisms, whereby it is possible to lock the inlet portion with certain angular orientations about the longitudinal axis.

### BRIEF DESCRIPTION OF THE DRAWINGS

The invention will now be described in more detail with reference to the accompanying drawing, in which

FIG. 1 is a schematic side elevation view of a washing gun according to the invention;

FIG. 2 is a side elevation view of a specific embodiment of the invention; and

FIG. 3 is a side elevation view of a second embodiment of the invention.

### DETAILED DESCRIPTION OF THE INVENTION

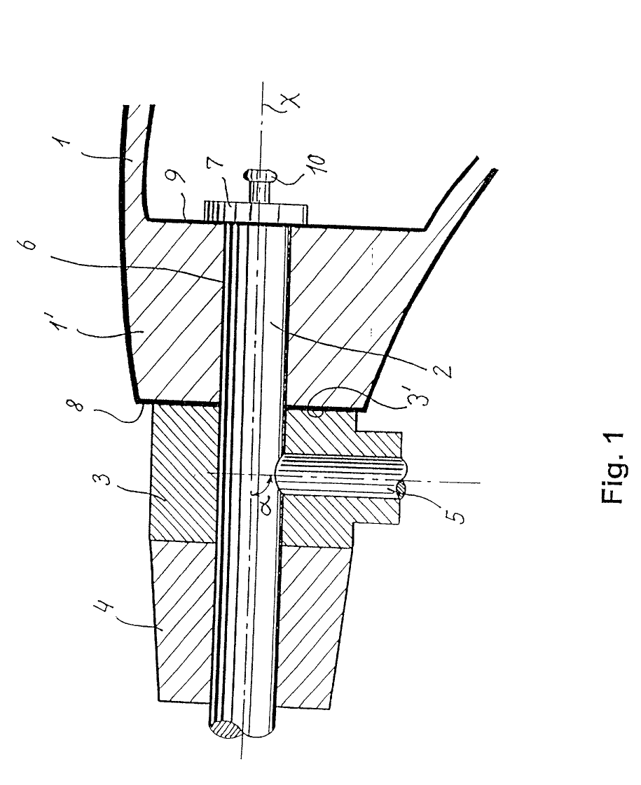

In the following, a detailed description of the invention is given. With reference to FIG. 1, there is shown a schematic side elevation partial sectional view of a washing gun according to the invention. The washing gun comprises the following main parts: a handgrip section 1 comprising a trigger and associated trigger mechanism, which are not shown in the figure, a cylindrical valve house 2 provided with an inlet portion 3 and a nozzle section 4. The valve house 2 has a longitudinal axis X, and an inlet 5 for the washing fluid is provided transversally in the inlet portion 3 and forming an angle α with the longitudinal axis X. In FIG. 1, α equals 90 degrees, but it is understood, that other values of a may also be used depending on the specific design of the washing gun, particularly of the handgrip section 1. The details of the valve itself is not a part of the present invention and will hence not be described. The valve is activated via a connection means 10 which is connected to a trigger provided at a suitable position on a handgrip part of the handgrip section 1 via a suitable trigger mechanism.

A first part 1′ of the handgrip section 1, i.e. the part hereof facing the inlet portion 3, is provided with a cylindrical bore 6, the diameter of which corresponds to the outer diameter of the cylindrical valve house 2. It is thus possible for the valve house 2—and hence for the inlet portion 3 and the nozzle section 4, which are both fixed to the valve house 2—to rotate relative to the handgrip section 1 about the longitudinal axis X through the valve house 2. The valve house 2 is axially retained in the handgrip section 1 due to abutment of one end face 3′ of the inlet portion 3 with a first end face 8 of said first part 1′ of the handgrip section 1 and abutment of a second end face 9 of said first part 1′ of the handgrip section 1 with a circumferential protrusion 7 fixed to—or formed as an integral part of—the valve house 2, and located in the proximity of that end of the valve house 2, which is inserted in the handgrip section 1.

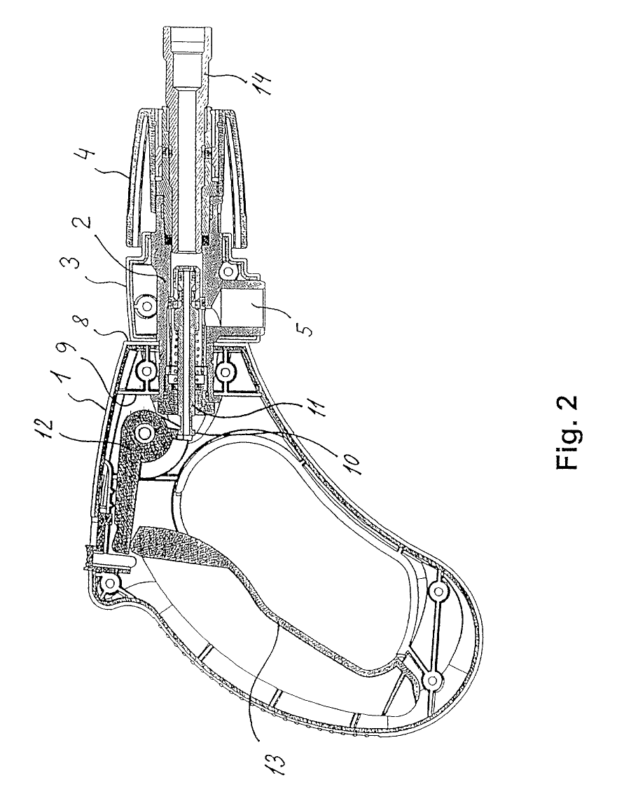

Referring to FIG. 2, there is shown a side elevation view of a specific embodiment of the invention. The inlet portion 3 is according to this embodiment formed as an integral part of the valve house 2, which valve house 2 comprises a centrally located valve member 11 provided with appropriate passages for providing fluid communication between the inlet 5 and the outlet 14 located in the nozzle section 4. Said fluid communication is established by activation of the trigger mechanism 12, 13, whereby the valve member 11 is being longitudinally displaced within the valve house 2. The nozzle section 4 can either be firmly attached to the inlet portion 3, and thereby rotating with the inlet portion 3, or the nozzle section 4 can be rotatably attached to the inlet portion 3, so that the nozzle section 4 can rotate relative to the inlet portion 3 about the longitudinal axis through the valve house 2. The nozzle section 4 can be coupled to the inlet portion 3 by various means, for instance by means of a so-called “Quick Coupling” or “Quick Connect” or by a so-called “Screw Coupling”. The coupling can be manually releasable or releasable with the aid of a specific tool.

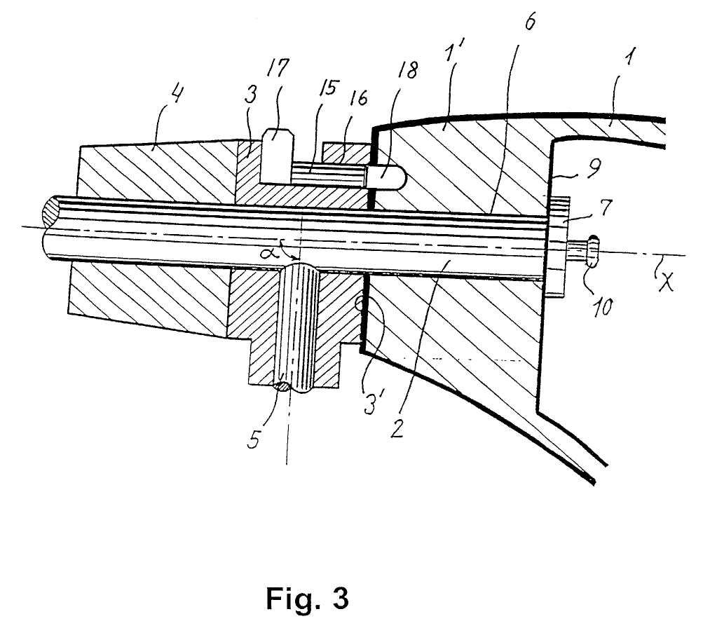

Referring now to FIG. 3 there is shown a second embodiment of the washing gun according to the invention. According to this embodiment the inlet portion 3 and the first part 1′ of the handgrip section 1 are provided with a retaining mechanism for locking the inlet portion 3 at one or more predetermined angular orientations about the longitudinal axis through the valve house 2. According to the embodiment shown in FIG. 3 this retaining mechanism comprises a longitudinally displaceable tap 15 slidably accommodated in the passage 16 within the body of the inlet portion 1 for engagement with one or more corresponding holes 18 within the first end face 8 of the handgrip section 1. The tap 15 is accessible from outside the inlet portion 3 for instance by means of a knob 17. A number of holes 18 can be provided at predetermined angular positions about the longitudinal axis through the valve house 2 thus making it possible to fix the inlet 5 at a number of predetermined orientations according to special needs. The tap 15 can be kept in its locked position in engagement with one of the holes 18 by means of a suitable biasing member urging the tap into engagement with the hole 18. A compression spring (not shown) may for instance be provided exerting a spring force on the tap in the direction towards the hole.

Instead of the retaining mechanism shown in FIG. 3 that locks the inlet portion 3 at predetermined fixed orientations it is also possible to replace the holes 18 by shallow recesses in the end face 8 of the handgrip section 1 and shape the corresponding end portion of the tap 15 to match the shape of the recess, thereby providing a brake mechanism retaining the inlet portion at the predetermined orientations unless a sufficiently large torque be exerted on the inlet portion, which torque overcomes the engagement between the end face of the tap and the recess, whereby it becomes possible to rotate the inlet portion about the longitudinal axis. It is even conceivable to combine the above two retainment mechanisms for instance by using the holes 18 as shown in FIG. 3 and arranging the tap 18 in such a manner that it can be displaced into two different operational positions, in the longitudinal direction, one in which the tap 18 is displaced completely into the hole 18, thus occupying substantially the total length of the hole 18 and the other one in which it is merely the end face of the tap 15 that is introduced into the hole 18 and where said torque is thus able to disengage the tap and the hole from each other.

The tap 15 could also be replaced by one or more rigid spheres accommodated for longitudinal displacement in passageways 16 in the body of the inlet portion 3 and biased for instance by means of springs towards the handgrip section 1. The first end face 8 of the handgrip section 1 is according to this embodiment provided with recesses shaped to be able to accommodate a portion of the spheres, thereby retaining the inlet portion at a predetermined number of orientations about the longitudinal axis. The spheres and the corresponding recesses according to this embodiment will become disengaged from each other by the provision of a sufficiently large torque, whereby the inlet portion can rotate about the longitudinal axis.

It is furthermore possible to replace the above described retainment mechanisms by a frictional break mechanism for instance comprising a circular track of frictional material placed concentrically about the longitudinal axis on the first end face 8 of the handgrip section 1 and also to provide the corresponding end face of the tap 15 with a suitable frictional material, such that the frictional force between the end face of the tap and the circular track impedes the rotation of the inlet portion about the longitudinal axis, when the tap 15 is in its operational position, where the end face of the tap presses against the circular track. It is furthermore possible to replace the tap (15) by a circular track of frictional material placed on the end face of the inlet portion adjacent the corresponding frictional track placed on the first end face 8 of the handgrip section as described above.

Although one embodiment of the present invention has been described above, it is understood that a person skilled in the art may conceive other embodiments of the invention without departing from the scope of the invention as defined by the following claims.

1. A washing gun comprising a handgrip section (1) and a valve house (2) provided with an inlet portion (3) comprising an inlet (5) for washing fluid and a nozzle section (4) placed coaxially with said valve house (2), where said valve house (2) is rotatably connected to said handgrip section (1) for rotation about a longitudinal axis (X) through the valve house (2) in such a manner that said inlet (5) during use of the washing gun can change its angular orientation over the total 360 degrees of rotation about the longitudinal axis.

2. A washing gun according to claim 1, where said inlet (5) for washing fluid is provided in said inlet portion (3) at an angle (α) relative to said longitudinal axis (X).

3. A washing gun according to claim 2, where said angle (α) is substantially equal to 90 degrees.

4. A washing gun according to any preceding claims 1 to 3, where said inlet portion (3) is provided with first retainment means (15, 16, 17) for engagement with corresponding second retainment means (18) on said handgrip section (1), whereby said inlet (5) can be retained during use of the washing gun at a number of predetermined angular orientations about said longitudinal axis (X).

5. A washing gun according to claim 4, where said first retainment means comprises a tap (15) accommodated for longitudinal displacement within a passageway (16) in the inlet portion (3) and said second retainment means comprises one or more holes (18) in the first end face (8) of the handgrip section (1) shaped to accommodate at least an end portion of said tap (15).

6. A washing gun according to claim 5, where said tap (15) is accessible from outside the inlet portion (3) by means of a knob (17).

7. A washing gun according to claim 5 or 6, where said tap (15) is provided with biasing means urging the tap (15) in the direction towards the handgrip section (1).

8. A washing gun according to any of the claims 5, 6 or 7, where said holes (18) are replaced by shallow recesses.

9. A washing gun according to claim 4, where said first retainment means comprises a sphere accommodated for longitudinal displacement within a passageway (16) in the inlet portion (3) and said second retainment means comprises one or more recesses in the first end face (8) of the handgrip section (1) shaped to accommodate a portion of said sphere.

10. A washing gun according to claim 5 or 6, where said sphere is provided with biasing means urging the sphere in the direction towards the handgrip section (1).

11. A washing gun according to any preceding claims 1 to 3, where said inlet portion (3) is provided with first frictional means for engagement with corresponding second frictional means on said handgrip section (1), whereby the rotation of said inlet (5) about said longitudinal axis (X) can be impeded during use of the washing.

12. A washing gun according to claim 11, where said first frictional means is a tap (15) according to any of the claims 5 to 7, the end face of which adjacent the first end face (8) of the handgrip section (1) is provided with a frictional material and where said second frictional means is a circular track of frictional material provided coaxially about the longitudinal axis (X) on the first end face (8) on the handgrip section (1).

13. A washing gun according to claim 11, where said first frictional means is circular track of frictional material provided coaxially about the longitudinal axis (X) on the end face of the inlet portion (3) facing the handgrip section (1) and where said second frictional means is a circular track of frictional material provided coaxially about the longitudinal axis (X) on the first end face (8) on the handgrip section (1).

14. A washing gun according to any of the preceding claims, where said valve house (2) is formed as a cylindrical body with said longitudinal axis (X), where a first longitudinal end of said valve house (2) is inserted in the handgrip section (1) through a cylindrical opening (6) in a first part (1′) of the handgrip section (1), the diameter of which cylindrical opening (6) corresponds to the outer diameter of said valve house (2), whereby the valve house (2) can rotate about said longitudinal axis (X) relative to the handgrip section (1).

15. A washing gun according to claim 14, where a first end face (8) of said first part (1′) of said handgrip section (1) is in axial abutment along said longitudinal axis (X) with one end face (3′) of said inlet portion (3), and a second end face (9) of said first part (1′) of said handgrip section (1) is in axial abutment along said longitudinal axis (X) with a circumferential protrusion (7) provided on said valve house (2), whereby said valve house (2) is axially restrained in said first part (1′) of said handgrip section (1).

16. A washing gun according to any preceding claim, where said valve house (2) at the longitudinal end hereof which is inserted into the handgrip section (1) is provided with means (10) co-operating with a trigger mechanism (12,13).

17. A washing gun according to any preceding claim, where said nozzle section (4) is attached to a second longitudinal end of said valve house (2) facing away from said handgrip (1).

18. A washing gun according to claim 17, characterised in that said nozzle section (4) is rotatably attached to said end of said valve house (2) for rotation relative to said inlet portion (3).
